(19) United States
(12) Patent Application Publication
(10) Pub. No.: US 2012/0210855 A1
(43) Pub. Date: Aug. 23, 2012

(54) SYSTEM AND METHOD FOR LAUNCHING COUNTERMEASURES TO MISSILE ATTACK

(75) Inventors: Dennis R. Clark, New Boston, NH (US); Jeffrey L. Jew, Brookline, NH (US)

(73) Assignee: BAE SYSTEMS INFORMATION AND ELECTRONIC SYSTEMS INTEGRATION INC., Nashua, NH (US)

(21) Appl. No.: 13/029,185

(22) Filed: Feb. 17, 2011

Related U.S. Application Data
(60) Provisional application No. 61/306,741, filed on Feb. 22, 2010.

(51) Int. Cl. B64D 1/02

(52) U.S. Cl. 89/1.51

(57) ABSTRACT

A system and method for launching countermeasures, such as flares and chaff, from an aircraft under attack by a missile. A plurality of countermeasure launchers are mounted preferably on the two sides and tail and nose of the aircraft and communicate with a missile detection and warning system mounted in the aircraft. Based upon the circumstances reported by the warning system, the appropriate countermeasure weapon or weapons are selected and dispensed. The circumstances reported are based upon the angle of elevation and azimuth angle of the approaching missile in relation to the aircraft and distance of the missile from the aircraft. Also, the speed and altitude of the aircraft are utilized in determining the countermeasures applied. The various responses are distinguished by the number and types of countermeasures dispensed, the dispense time of the countermeasures and the particular launcher or launchers used, based upon the type of aircraft being protected.

### CROSS REFERENCE TO RELATED APPLICATION

This application claims priority from U.S. Provisional Application Ser. No. 61/306,741, filed Feb. 22, 2010; the disclosure of which is incorporated herein by reference.

### BACKGROUND OF THE INVENTION

1. Technical Field

The invention relates to a system and method for launching countermeasures such as flares and chaff from one or more dispensers mounted on an aircraft to direct the missile away from the aircraft. More particularly, the invention relates to such a system and method in which the dispense pattern is determined based upon the angle of approach (AOA) of the incoming missile. Even more particularly, the invention relates to such a system and method in which a look-up table of countermeasure responses is incorporated into the dispense mechanism, which is indexed by the azimuth angle of angle of elevation, the estimated distance of the missile to the aircraft, the aircraft speed and altitude, all of which are entered into an onboard computer whereupon the computer through the appropriate software will launch the most efficient number of flares or chaff from the appropriate dispenser or combination of dispensers including the number and types of flares dispensed and the dispense time of the flares.

2. Background Information

It is well understood that most military aircraft today are either shot down or damaged by missile attacks fired from land-based missile launchers or from air-to-air missile attacks. These missiles are usually guided by infrared sensors, radar sensors or both. These missiles are active devices that emit various signals and emissions that are detected by the target (aircraft) which uses the detected signals to evade or launch a countermeasure against the incoming missile. The incoming missile approaches the aircraft at a particular elevation angle and azimuth angle with a particular speed, all of which can be detected by the warning system of the aircraft's counter-measure system which can be an optical, radar or other various detection systems. These measurements are supplied to an onboard computer which then determines the preferred countermeasure to be dispensed against the incoming missile, such as one or more flares and/or chaffs or other types of known countermeasures from one or more dispensers located at various locations on the aircraft.

Radar sensors are highly accurate in identifying and locating their targets. They have the disadvantage that they are active devices that emit radar signals, and their emissions may be detected by the target and used to evade or to launch a counter-attack against the radar source.

Infrared sensors, on the other hand, are passive devices that do not reveal their presence or operation. The great majority of aircraft losses to hostile attacks over the past 20 years have been to infrared-guided missiles. In most cases, the pilots of the aircraft that were shot down were not aware that they were under attack until the infrared-guided missile detonated.

Infrared-guided missiles have the disadvantage that they typically must be initially positioned much more closely to their potential targets in order for the infrared sensor of the missile to be effective, as compared with a radar-guided missile. The fields of view of the infrared sensors are usually quite narrow, on the order of a few degrees. In most cases, the infrared sensor must therefore acquire its potential target prior to launch of the missile and remain “locked onto” the target for the entire time from launch until intercept. If the acquisition is lost during the flight of the missile, it is usually impossible to re-acquire the target without using an active sensor that warns the target of its presence.

There are a number of countermeasures to defeat infrared-guided missiles. Historically, the most common countermeasure has been the use of flares that produce false signals to confuse the infrared sensor. The current generation of infrared-guided missiles utilize counter-countermeasures programmed to ignore flares, based upon distinguishing features of the flares such as their different motion than the previously acquired target and/or their different heat-emitting properties as compared with the previously acquired target. Lamps and directional lasers may be used to blind or confuse the infrared sensor, but these approaches have drawbacks in respect to size, weight, complexity, and power requirements.

In general, current countermeasure systems obtain incoming data and the only discriminator is the hemisphere in which the missile is detected. If possible, the countermeasures are ejected from a dispenser closest to the missile warning which may not always be the best dispense location. Also, the optimum number of flares or chaff dispensed is only estimated resulting in the less than optimum number of flares or chaff and dispensers utilized, not providing the optimum protection to the aircraft under attack. Usually the flares or chaff are dispensed from the same side of the aircraft as the approaching missile which may not provide the best dispense pattern. Therefore, there exists a need for systems and methods to better protect aircraft from attack.

### BRIEF SUMMARY OF THE INVENTION

The method and system of the present invention upon detecting the incoming missile selects the appropriate countermeasure which distinguishes by number and type of flares dispensed, the dispense time of flares and the flare dispenser or dispensers used by providing a software program in the computer of the missile warning system, a look-up table of countermeasure responses indexed by the azimuth approach angle of the incoming missile, the elevation angle of the incoming missile and the estimated distance of the missile from the aircraft. Also included in the table or calculation is the speed and altitude of the aircraft which based upon an optimal response will elect and cause to be ejected from the aircraft, the optimum number and type of flares, the dispense time of the flares and the particular flare dispenser or combination of dispensers used for dispensing the flares in order to provide the optimum countermeasure based upon the characteristics of the incoming missile threat.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example diagrammatic view showing an aircraft under missile attack.

FIG. 2 is a block diagram of the system for the deployment of the countermeasure flares in response to the output of a warning receiver on the aircraft.

FIG. 3 is one example of a look-up table and sequencing of the flare discharged used in carrying out the method and system of the present invention.

FIG. 4 illustrates example locations that countermeasures can be discharged from on an example aircraft.

FIG. 5 illustrates an embodiment of a method for launching countermeasures to a missile attack.

Similar numbers refer to similar parts throughout the drawings.

### DETAILED DESCRIPTION OF THE INVENTION

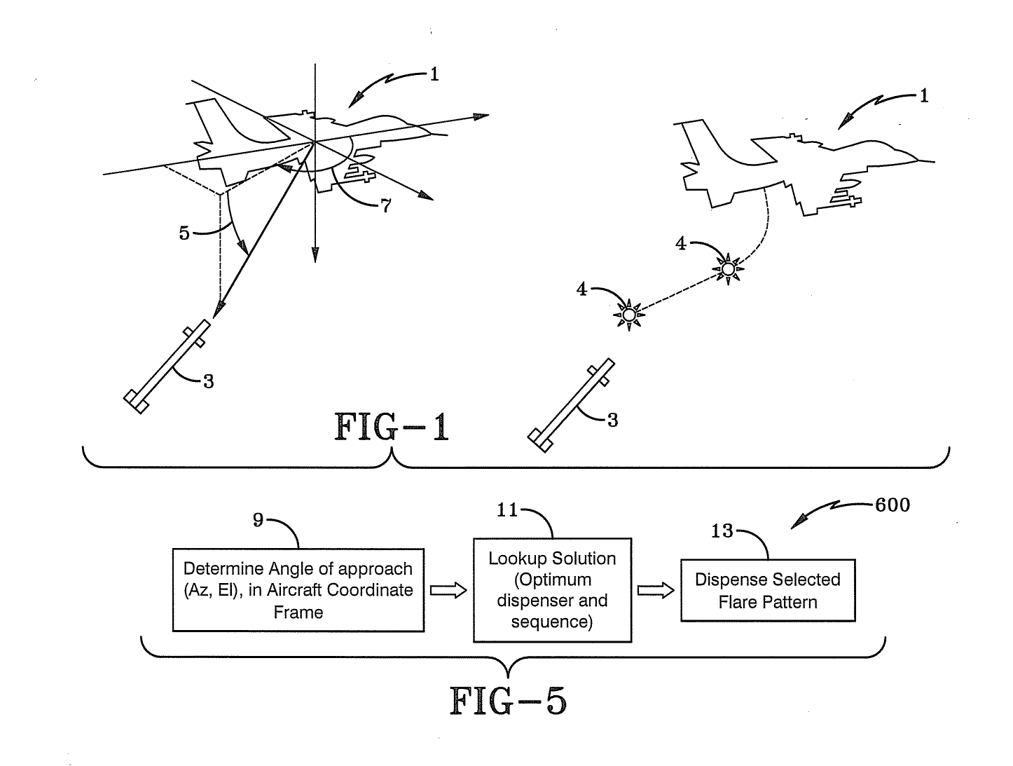

An aircraft indicated generally at 1, is shown on the left in FIG. 1 under attack by an incoming missile 3 and on the right dispensing a sequence of flares 4 or other countermeasures. The aircraft will contain a type of missile warning and detection system, many types of which are well-known in the art which will detect the incoming missile 3. The detection system will provide to the onboard countermeasure system (CM) the elevation angle of missile 3, indicated at 5, and the azimuth angle of missile 3, indicated at 7, preferably measured with respect to the pilot of the aircraft. The detection system also estimates the distance of the missile to the aircraft. The speed of aircraft 1 and its altitude also is known by the countermeasures system. All of these detected and known factors are supplied to the onboard computer of the countermeasure system.

The onboard computer contains a program which based upon the various factors supplied thereto as discussed above, determines the type of countermeasures to be dispensed, such as flares 4, chaff or other known missile deterrents. It also determines the number of flares, chaff etc. to be dispensed, the sequence that the flares or chaff (or both) are to be dispensed and from which dispenser or combination of dispensers they are to be dispensed.

The aircraft will normally be equipped with a number of dispensers at various locations in the aircraft frame, such as on both sides of the frame, both in the nose and tail of the frame, as well as on the top and bottom of the frame. The computer of the countermeasure control system will then initiate the number and types of flares or chaff to be dispensed as well as the dispense pattern, such as the dispense timing and the dispenser to be used.

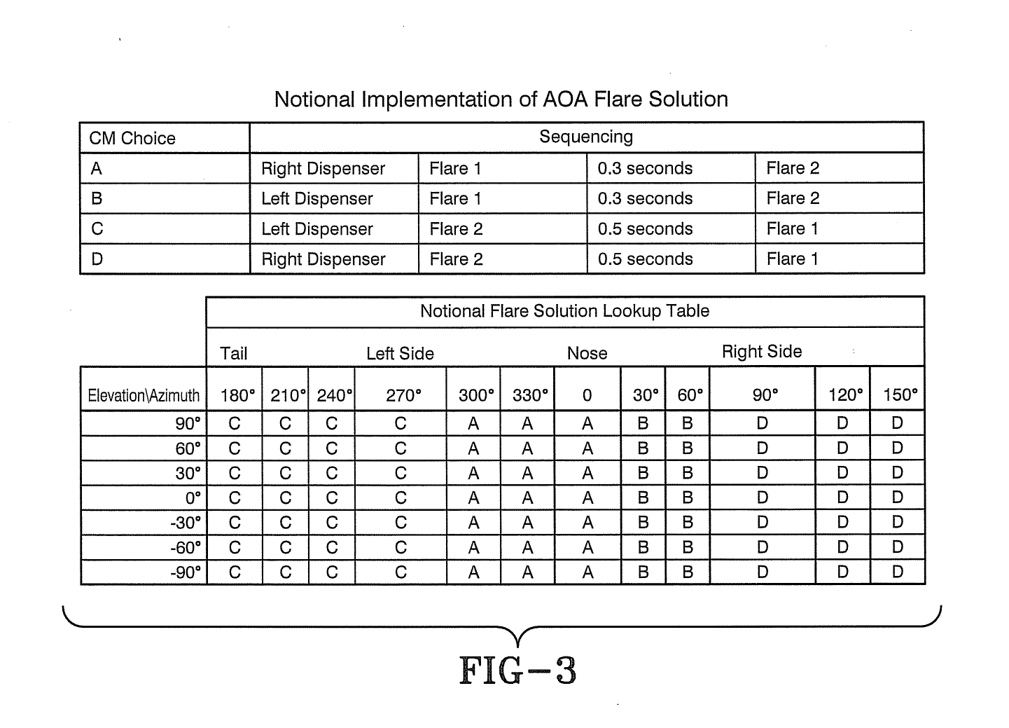

As an example, upon the onboard detection system determining that missile 3 is approaching the aircraft with an angle of elevation of −30° and at an azimuth angle of 240° from the left side of the aircraft it will actuate the left dispenser (CM Choice C) with a sequencing pattern of a type 2 flare and 0.5 seconds later a type 1 flare. This is illustrated in FIG. 3 which represents a type of lookup table or software that can be incorporated in the computer of the countermeasure (CM) system.

FIG. 4 illustrates and example airplane with six different locations from where anti-missile devices (e.g. dispensers) can be located. The dispenser can be locate at the front 701, rear 702, right front 703, left front 704, right rear 705 and the left rear 706 of the aircraft. The countermeasure extracted from the table shown in FIG. 3 can include actions by dispensers located at an one or more of these locations.

Returning to FIG. 3, a second example includes an incoming missile with an angle of elevation of +60° and an azimuth angle of 60° with respect to the nose of the aircraft. In this case, the table would select CM Choice B. This in turn will dispense a type 1 flare from the left dispenser with a type 2 flare being dispensed 0.3 seconds later.

It is readily understood that the number of flares (or chaff), the types of flares and the sequencing thereof, and the particular dispenser or dispensers from which they are being dispensed will vary depending upon the type of aircraft, such as a high speed fighter, a larger slower bomber, a helicopter etc. The particular lookup table and sequencing is merely an example of how the method and systems implementing the present invention can be implemented. The important aspect is that the CM system will be inputted with the various factors discussed above, namely the angle of elevation and azimuth of the incoming missile for use in determining the flare dispensing sequence and the particular dispenser or combination of dispensers from which they are dispensed.

Also, the particular type of flare (or chaff) to be dispensed will be further determined by inputting into an equation the speed of the incoming missile and speed and altitude of the aircraft.

In summary, the present invention is based upon the angle of approach (AOA) of the threat (missile) to the aircraft and then from a computerized lookup table determines the side of dispense, left or right, or nose or tail of the aircraft or combination thereof, based upon the angle of approach of the attacking missile as well as the type of countermeasure to be dispensed.

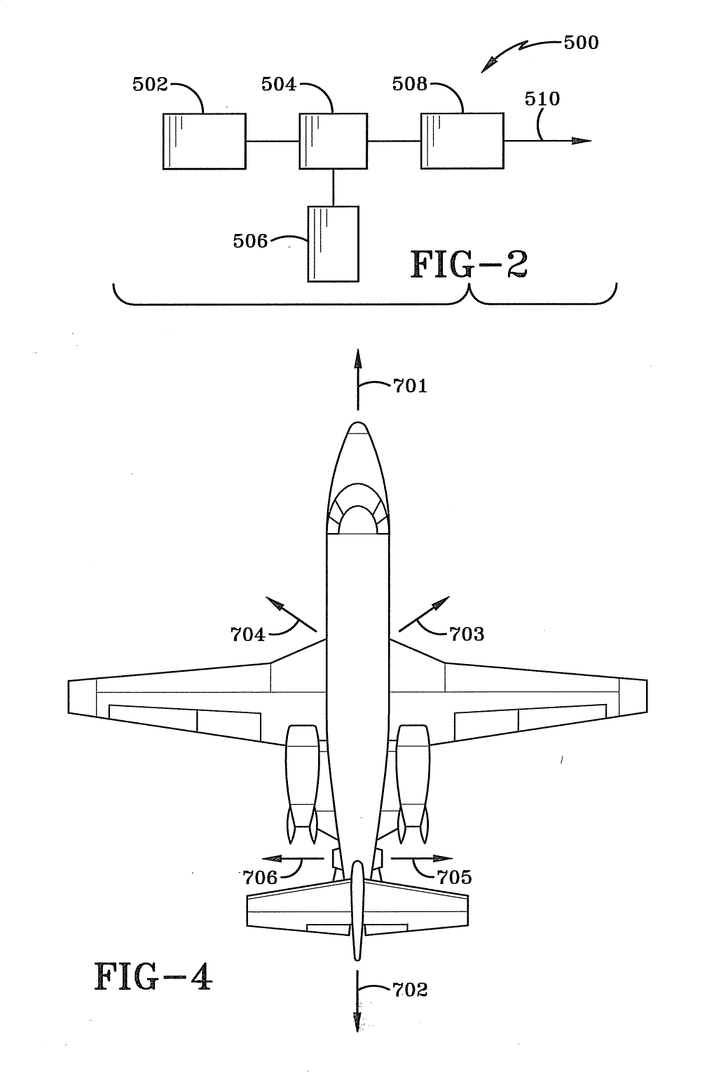

FIG. 2 represents a system 500 that launches countermeasure based on a table lookup. The system 500 includes detection logic 502, table lookup logic 504, a table of data 506, execution logic 508 and one or more control lines 510. The detection logic 502 may include radar, one or more sensors and/or other devices that provide indications that a missile or other projectile is approaching an aircraft. The detection logic 502 calculates an angle elevation and the azimuth of an approaching projectile. The angle elevation and the azimuth are provided in the table loop logic 504. In some embodiments of system 500, the detection logic 502 may not be implemented and instead signals from radar, sensors and other devices already incorporated in the aircraft can be used detect the projectile approaching aircraft. Data from the detection logic 502 describing the incoming projectile may be directly input to the table lookup logic 504. Of course, a person of ordinary skill in the art will realize that the detection logic 502 can calculate other information related to the incoming projectile other than the angle elevation and the azimuth and can provide other information to the table loop logic 504.

The table loop logic 504 generates an index to the table of data 506, based at least in part, on the angle elevation and the azimuth. The index can be an address into a memory that stores data associated to the previously discussed table of FIG. 3. For example, the azimuth can be the lower address bits of an address into the table 506 and the elevation can be upper address bits of the address. Alternatively, the table loop logic 504 may use a hash function to generate the index based on the angle elevation, the azimuth and/or other data. In one configuration, the hash function would map this data to a single index. The table of data 506 can be a read only memory (ROM) or another type of memory.

The execution logic 508 receives data that was extracted from the table of data 506 by the table loop logic 504. The execution logic 508 will execute the countermeasure (CM) that is represented by the extracted data. The CM may be similar to CMs A, B, C and D discussed above with reference to FIG. 3. The execution logic 508 has a timer to time when multiple missile deterrents are to be activated at different times.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 5 illustrates a method 600 for launching countermeasures to a missile attack. The method begins by determining an angle of approach of a projectile, at 9, that is approaching an aircraft. The angle of approach can be describe by determining an azimuth angle and an elevation angle of the projectile relative to the aircraft. Based on the angle of approach an optimal countermeasure response is looked up, at 11. For example, an address based on the azimuth angle and elevation angle can be used to generate an address that is used to extract the optimum response from a lookup table. The method 600 dispenses the optimal flare pattern, at 13.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A method of launching countermeasures from one or more of a plurality of dispensers mounted on an aircraft comprising the steps of:
detecting the angle of approach of a hostile missile;
initiating a prestored dispense program determining an optimum dispenser and sequence of dispensing countermeasures therefrom based upon the detected angle of approach of the hostile missile.

2. The method defined in claim 1 including the steps of determining the angle of approach by determining the angle of elevation and azimuth angle of the hostile missile.

3. The method defined in claim 1 including the step of detecting a distance of the missile to the aircraft and supplying said detected distance to the dispense program.

4. The method defined in claim 1 including the step of determining the aircraft speed and altitude and supplying said speed and altitude to the dispense program.

5. The method defined in claim 1 including the step of storing the dispense program in an onboard computer of the aircraft.

6. The method defined in claim 1 including the step of determining the number of and type of countermeasures to be dispensed and from a preferred dispenser based upon the angle of approach of the hostile missile.

7. The method defined in claim 1 including the step of dispensing the countermeasures in a preferred time sequence.

8. A system for comprising:
detection logic configured to detect a projectile is approaching an aircraft and configured to determine a plurality of characteristics associated with the projectile;
table lookup logic configured to generate an address based on the plurality of characteristics and to extract from a lookup table with a plurality of predefined countermeasures an extracted countermeasure, wherein the plurality of predefined countermeasures are pre-stored in the lookup table; and
execution logic configured to control the execution of the extracted countermeasure so that the aircraft avoids the projectile.

9. The system defined of claim 8 wherein the extracted countermeasure is comprised of a first countermeasure and a second countermeasure, wherein the execution logic is configured to execute the first countermeasure at a first time and the second countermeasure at a second time that is different from the first time.

10. The system defined of claim 8 further comprising:
a memory, wherein the lookup table is implemented in the memory.

11. The system defined of claim 8 wherein the table lookup logic is configured to generate the address based on the angle of elevation and the angle of azimuth.

12. The system defined of claim 8 wherein the execution logic is configured to the execution of the extracted countermeasure to have flares launched from one or more of the group of: a dispenser on the front right side of the aircraft, a dispenser on the front left side of the aircraft, a dispenser on the back right side of the aircraft, a dispenser on the back left side of the aircraft, the nose of the aircraft, and the rear of the aircraft.

13. The system defined of claim 8 wherein the table lookup logic further comprises:
a hash function, wherein table lookup logic is configured to generate the address based on the hash function.

14. A method comprising:
detecting a projectile is approaching an aircraft;
determining a plurality of parameters associated with the projectile;
generating an address based on the plurality of parameters;
using the address to retrieve a retrieved countermeasure from one of a plurality of countermeasures; and
executing the retrieved countermeasure so that the aircraft avoids the projectile.

15. The method of claim 14 wherein the determining a plurality of parameters further comprises:
determining one or more of the group of: an azimuth angle of the projectile, an elevation angle of the projectile and a range of the projectile.

16. The method of claim 14 wherein the generating an address further comprises:
determining a first portion of the address that corresponds to the azimuth angle and a second portion of the address that corresponds to the elevation angle of the projectile.

17. The method of claim 14 wherein the using the address to retrieve a retrieved countermeasure further comprises:
retrieving the retrieved countermeasure by extracting the retrieved countermeasure from a memory using the address.

18. The method of claim 14 wherein the executing the retrieved countermeasure further comprises:
dispensing a first projectile avoidance countermeasure at a first time and dispensing a second projectile avoidance countermeasure at a second time that is different than the first time.

19. The method of claim 14 wherein the executing the retrieved countermeasure further comprises:
dispensing at least one of the group of: flair and metallic chaff.

20. The method of claim 14 wherein at least a portion of the method is executed by software.
